(19) United States
(12) Patent Application Publication
(10) Pub. No.: US 2026/0346846 A1
(43) Pub. Date: Nov. 5, 2026

(54) VEHICLE CONTROL DEVICE

(71) Applicants: TOYOTA JIDOSHA KABUSHIKI KAISHA, Toyota-shi Aichi-ken (JP); DENSO CORPORATION, Kariya-shi Aichi (JP)

(72) Inventors: Ryuta HASHIMOTO, Setagaya-ku Tokyo-to (JP); Takahiro SETA, Yokohama-shi Kanagawa-ken (JP)

(73) Assignees: TOYOTA JIDOSHA KABUSHIKI KAISHA, Toyota-shi Aichi-ken (JP); DENSO CORPORATION, Kariya-shi Aichi (JP)

(21) Appl. No.: 18/774,213

(22) Filed: Jul. 16, 2024

(30) Foreign Application Priority Data
Jul. 18, 2023 (JP) 2023-117105

(51) Int. Cl. B60W 30/18; B60W 60/00

(52) U.S. Cl. CPC B60W 30/18163; B60W 60/001

(57) ABSTRACT

A vehicle control device has a processor configured to determine whether or not timing to initiate a scheduled first lane change is to be altered based on environment information for a vehicle surroundings, to plan a second lane change based on the environment information for the vehicle surroundings, when it has been determined that the timing to initiate the first lane change is to be altered, and to decide on a mode of control for the second lane change, when the second lane change has been planned, based on a reason for executing the first lane change, or on the environment information for the vehicle surroundings for which the timing to initiate the first lane change has been altered.

### CROSS-REFERENCE TO RELATED APPLICATIONS

This application claims priority to Japanese Patent Application No. 2023-117105 filed Jul. 18, 2023, the entire contents of which are herein incorporated by reference.

### FIELD

The present disclosure relates to a vehicle control device.

### BACKGROUND

When a vehicle is to exit from a traveling road on which the vehicle is currently traveling onto a branching road, the automatic control device of the vehicle decides a lane change completion location on the target lane within the traveling road, which is adjacent to the lane on the branching road. The lane change completion location is a location on the target lane where the vehicle is to complete movement to the lane on the branching road. When the vehicle is traveling on another lane other than the target lane within the traveling road, the vehicle moves to the target lane, and then moves to the lane of the branching road up to the lane change completion location.

However, when a congested zone exists between the current location of the vehicle and the lane change completion location, it may be difficult to ensure safe distance between the vehicle and other vehicles within the congested zone while the vehicle moves between lanes by automatic control.

Therefore, when the vehicle is to move to a target lane, a lane change may be carried out to move the vehicle to the target lane after the vehicle has passed through the congested zone, or a lane change may be carried out to move the vehicle to the target lane before the vehicle reaches the congested zone.

Japanese Unexamined Patent Publication No. 2021-056616, for example, proposes a vehicle control device which, when a branch exists in front of the path of one's own vehicle to enter after having changed lanes and the degree of congestion indicated by congestion information is high, allows lane change control from a point before the point where lane change control is possible if the degree of congestion indicated by the congestion information is low.

### SUMMARY

The timing for initiating a lane change may vary, depending on the presence of a difficult traveling zone such as a congested zone between the current location of the vehicle and the lane change completion location, as in the case described above. A lane change where the timing has been altered in this case is expected to allow more successful movement of the vehicle between lanes.

For example, deciding on a mode for a lane change after the originally planned timing for the lane change has been altered, based on a given reason for altering the timing for initiating the lane change, may increase the likelihood of successful movement of the vehicle between lanes.

It is an object of the present disclosure to provide a vehicle control device that decides on a mode of a lane change after the timing to initiate has been altered based on the reason for altering the timing for initiating the originally planned lane change.
(1) One embodiment of the present disclosure provides a vehicle control device. The vehicle control device has a processor configured to determine whether or not timing to initiate a scheduled first lane change is to be altered based on environment information for vehicle surroundings, plan a second lane change based on the environment information for the vehicle surroundings, when it has been determined that the timing to initiate the first lane change is to be altered, and decide on a mode of control for the second lane change based on a reason for executing the first lane change, or on the environment information for the vehicle surroundings for which the timing to initiate the first lane change has been altered, when the second lane change has been planned.
(2) The vehicle control device of embodiment (1) above, the processor is further configured to decide on the mode of control for the second lane change so as to increase a degree of participation of a driver when the reason for executing the first lane change is a lane change for the vehicle to reach a destination location, or when the environment information for the vehicle surroundings indicates that the vehicle is no longer able to reach the destination location.
(3) The vehicle control device of embodiment (1) or (2) above, the processor is further configured to decide on the mode of control for the second lane change so as to lower the degree of participation of the driver, when the environment information for the vehicle surroundings does not indicate that the vehicle is no longer able to reach the destination location.
(4) The vehicle control device of any one of embodiments (1) to (3) above, the processor is further configured to decide on the mode of control for the second lane change while also deciding on the mode of control so as to increase the likelihood of a successful lane change by automatic control.
(5) The vehicle control device of embodiment (1) above, the processor is further configured to decide on the mode of control for the second lane change, based on (A) the reason for executing the first lane change, or (B) the environment information for the vehicle surroundings for which the timing to initiate the first lane change has been altered, together with (C) the difference between the timing to initiate the second lane change and the timing to initiate the first lane change.

The vehicle control device of the present disclosure exhibits an effect whereby the mode of a lane change after its timing to initiate has been altered is decided based on the reason for executing the originally planned lane change or the reason for altering the timing for initiating the lane change, thereby increasing the likelihood of making a successful lane change after the timing to initiate has been altered.

The object and advantages of the present disclosure will be realized and attained by the elements and combinations particularly specified in the claims. It is to be understood that both the foregoing general description and the following detailed description are exemplary and explanatory and are not restrictive of the present disclosure, as claimed.

### BRIEF DESCRIPTION OF DRAWINGS

FIG. 1A is a diagram illustrating operation of the traveling lane planning device of the embodiment in overview, showing the operation without a difficult traveling zone.

FIG. 1B is a diagram illustrating operation of the traveling lane planning device of the embodiment in overview, showing the operation with a difficult traveling zone.

FIG. 2 is a hardware configuration diagram of a vehicle in which a traveling lane planning device is mounted.

FIG. 3 is an example of an operation flow chart for vehicle control processing by a traveling lane planning device.

FIG. 4 is an example of an operation flow chart for mode decision processing by a traveling lane planning device.

FIG. 5 is a diagram illustrating a different example of mode decision processing by the traveling lane planning device of the embodiment.

### DESCRIPTION OF EMBODIMENTS

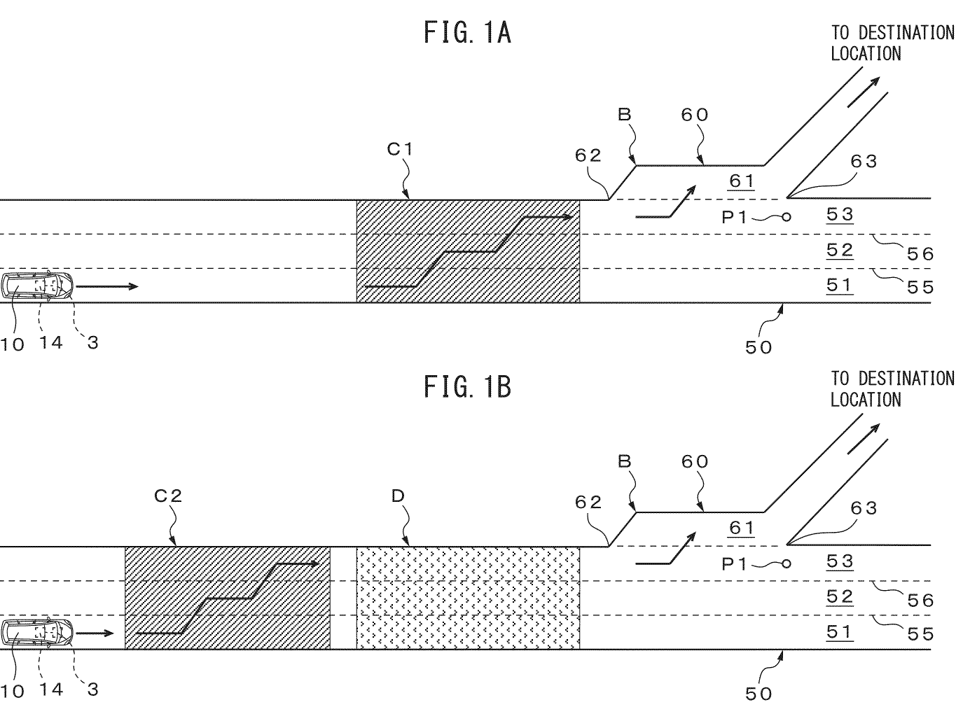

FIGS. 1A and 1B are diagrams illustrating operation of the traveling lane planning device 14 of the embodiment in overview. FIG. 1A shows operation without a difficult traveling zone, and FIG. 1B shows operation with a difficult traveling zone.

A communication device 3 and the traveling lane planning device 14 are mounted in the vehicle 10. Specifically, the traveling lane planning device 14 selects a lane within the road on which the vehicle 10 is traveling, in the nearest driving zone selected from the navigation route, and creates a traveling lane plan representing a scheduled traveling lane on which the vehicle 10 is to travel. The traveling lane planning device 14 is an example of a vehicle control device. The vehicle 10 may also be a self-driving vehicle.

The vehicle 10 is traveling on a road 50 and is scheduled to exit from a branching location B to a road 60 to proceed toward the destination location.

The road 50 has three lanes 51, 52 and 53. The lane 51 and lane 52 are divided by a lane marking line 55, and the lane 52 and lane 53 are divided by a lane marking line 56. The traffic lane 53 of the road 50 and the lane 61 of the road 60 are connected between a branch start location 62 and a branch end location 63, at the branching location B.

The vehicle 10 is currently traveling in the lane 51. According to the traveling lane plan, after having made two lane changes to move from the lane 51 to the lane 53, the vehicle 10 is scheduled to move from the lane 53 of the road 50 to the lane 61 of the road 60.

The traveling lane planning device 14 sets on the lane 53 a lane change completion location P1 where movement of the vehicle 10 from the lane 53 onto the lane 61 is to be completed. In the example shown in FIG. 1A, the lane change completion location P1 matches the branch end location 63 in the traveling direction of the vehicle 10. The traveling lane planning device 14 generates a lane change plan C1 for movement from the lane 53 to the lane 61 before it reaches the lane change completion location P1. The lane change plan C1 includes moving from the lane 51 to the lane 52 and moving from the lane 52 to the lane 53. The lane changes included in the lane change plan C1 are scheduled for the purpose of reaching the destination location of the vehicle 10.

The traveling lane planning device 14 has three modes of lane change control: non-approval mode, proposal-approval mode and manual control mode. In non-approval mode, a lane change that the traveling lane planning device 14 has determined to be necessary is carried out by the vehicle 10 without receiving approval by the driver. In proposal-approval mode, a lane change that the traveling lane planning device 14 has determined to be necessary is carried out by the vehicle 10 after having received approval by the driver. In manual control mode, the driver judges the necessity of lane changes. Manual control mode includes cases where a lane change operation is executed manually by the driver, and cases where a lane change operation is executed automatically by the vehicle 10.

The degree to which the driver participates in the lane change is higher in the order: non-approval mode, proposal-approval mode, manual control mode.

In the examples shown in FIGS. 1A and 1B, the traveling lane planning device 14 has scheduled a lane change plan C1 in non-approval mode.

The traveling lane planning device 14 receives zone information, representing the location of a difficult traveling zone D where traveling of the vehicle 10 is difficult, from an external server (not shown), via the communication device 3. The zone information includes a location in the difficult traveling zone located in a predetermined range of the navigation route of the vehicle 10, in the traveling direction from the current location of the vehicle 10. The difficult traveling zone may be, for example, a congested zone, a frozen road surface zone or a construction zone. The location of the difficult traveling zone is an example of environment information for the vehicle surroundings.

In the example shown in FIG. 1A, the zone information does not include the fact that a difficult traveling zone exists between the current location of the vehicle 10 and the lane change completion location P1.

After having moved from the lane 51 to the lane 53 based on the lane change plan C1, the vehicle 10 has moved from the lane 53 to the lane 61 before the lane change completion location P1.

In the example shown in FIG. 1B, on the other hand, the zone information does include the fact that the difficult traveling zone D exists between the current location of the vehicle 10 and the lane change completion location P1.

Since the difficult traveling zone D exists, the traveling lane planning device 14 alters the timing to begin the scheduled lane change plan C1. The traveling lane planning device 14 schedules a new lane change plan C2 between the current location of the vehicle 10 and the difficult traveling zone D.

The lane change plan C2 includes moving from the lane 51 to the lane 52 and moving from the lane 52 to the lane 53. The timing for execution of the lane change plan C2 is earlier than in the lane change plan C1.

The traveling lane planning device 14 decides on the mode of control for the lane change in the lane change plan C2, based on the reason for executing the lane change in lane change plan C1. The environment information for the vehicle surroundings is information that was not recognized when scheduling the lane change plan C1.

Since the reason for scheduling the lane change plan C1 was for the vehicle 10 to reach the destination location, the traveling lane planning device 14 decides on a mode of control for the lane change in the lane change plan C2 so that the degree of participation of the driver is higher.

The previous mode was non-approval mode, and therefore the traveling lane planning device 14 decides on proposal-approval mode or manual control mode as the mode of control for the lane change in the lane change plan C2.

If the vehicle 10 is unable to move to the lane 53 before reaching the lane change completion location P1, the vehicle 10 will not be able to exit from the road 50 to the road 60.

The likelihood of a successful lane change can be increased by executing the lane change in the lane change plan C2 in such a manner so as to increase the degree of participation of the driver.

With the traveling lane planning device 14 of this embodiment described above, it is possible to decide on a mode of lane change after its timing to initiate has been altered, based on the reason for executing the originally planned lane change, thereby increasing the likelihood of a successful lane change after the timing to initiate has been altered.

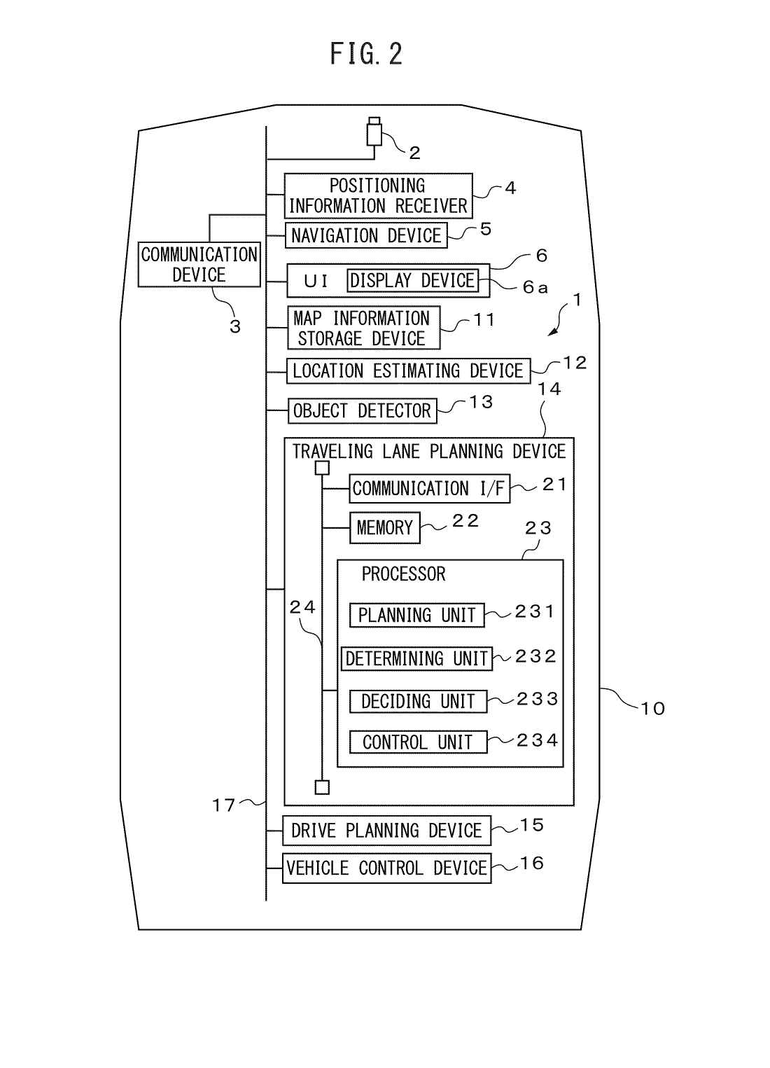

The vehicle 10 in which the traveling lane planning device 14 is mounted will now be explained with reference to FIG. 2. FIG. 2 is a hardware configuration diagram of a vehicle 10 in which a traveling lane planning device 14 is mounted.

The vehicle 10 has a camera 2, a communication device 3, a positioning information receiver 4, a navigation device 5, a user interface (UI) 6, a map information storage device 11, a location estimating device 12, an object detector 13, a traveling lane planning device 14, a drive planning device 15 and a vehicle control device 16.

The camera 2, communication device 3, positioning information receiver 4, navigation device 5, UI 6, map information storage device 11, location estimating device 12, object detector 13, traveling lane planning device 14, drive planning device 15 and vehicle control device 16 are connected in a communicable manner through an in-vehicle network 17 that conforms to controller area network standards.

The camera 2 is mounted inside the vehicle 10 and directed toward the front of the vehicle 10. The camera 2, for example, acquires a camera image in which the environment of a predetermined region ahead of the vehicle 10 is shown, at a predetermined cycle. The camera image can show the road in the predetermined region ahead of the vehicle 10, and road features such as surface lane marking lines on the road. A camera image acquired by the camera 2 may also include another vehicle which is located in front of the vehicle 10.

The camera 2 has a 2D detector composed of an array of photoelectric conversion elements with visible light sensitivity, such as a CCD or C-MOS, and an imaging optical system that forms an image of the photographed region on the 2D detector. The camera image is an example of environment information representing the environment ahead of the vehicle 10.

Each time a camera image is acquired, the camera 2 outputs the camera image and the camera image acquisition time at which the camera image was acquired, through the in-vehicle network 17 to the location estimating device 12 and object detector 13. The camera image is also used for processing at the location estimating device 12 to estimate the location of the vehicle 10. At the object detector 13, the camera image is used for processing to detect other objects surrounding the vehicle 10.

The communication device 3 is an example of a device communication unit, and it has an interface circuit for connecting the traveling lane planning device 14 to a macrocell base station (not shown). The communication device 3 is configured in a communicable manner with an external server (not shown) via a macrocell base station and communication network (not shown).

The positioning information receiver 4 outputs positioning information that represents the current location of the vehicle 10. The positioning information receiver 4 may be a GNSS receiver, for example. The positioning information receiver 4 outputs positioning information and the positioning information acquisition time at which the positioning information has been acquired, to the navigation device 5 and map information storage device 11, each time positioning information is acquired at a predetermined receiving cycle.

Based on the navigation map information, the destination location of the vehicle 10 input through the UI 6, and positioning information representing the current location of the vehicle 10 input from the positioning information receiver 4, the navigation device 5 creates a navigation route from the current location to the destination location of the vehicle 10. The navigation route includes information relating to the locations of right turns, left turns, merging and branching. When the destination location has been newly set or the current location of the vehicle 10 has exited the navigation route, the navigation device 5 creates a new navigation route for the vehicle 10. Every time a navigation route is created, the navigation device 5 outputs the navigation route to the location estimating device 12 and the traveling lane planning device 14, via the in-vehicle network 17.

The UI 6 is an example of the notification unit. The UI 6, controlled by the navigation device 5 and traveling lane planning device 14, notifies the driver of the vehicle 10 traveling information. The traveling information of the vehicle 10 includes information relating to the current location of the vehicle, execution of lane changes, and the current and future route of the vehicle 10, such as the navigation route. The UI 6 has a display device 6a such as a liquid crystal display or touch panel, for display of the traveling information. The UI 6 may also have an acoustic output device (not shown) to notify the driver of traveling information. The UI 6 also creates an operation signal in response to operation of the vehicle 10 by the driver. The operation information may be, for example, a destination location, transit points, vehicle speed or other control information. The UI 6 also has a touch panel or operating button, for example, as an input device for inputting operation information from the driver to the vehicle 10. The UI 6 outputs the input operation information to the navigation device 5 and the traveling lane planning device 14, via the in-vehicle network 17.

The map information storage device 11 stores wide-area map information for a relatively wide area (an area of 10 km² to 30 km², for example) that includes the current location of the vehicle 10. In some embodiments, the map information has high-precision map information including three-dimensional information for the road surface, the speed limit for the road, the curvature of the road, and information for the types and locations of structures and road features such as road lane marking lines. The map information includes locations of difficult traveling zones such as congested zones, frozen road surface zones, and construction zones.

The map information storage device 11 receives the wide-area map information from an external server via a macrocell base station, by wireless communication through a communication device 3 mounted in the vehicle 10, in relation to the current location of the vehicle 10, and stores it in the storage device. Each time positioning information is input from the positioning information receiver 4, the map information storage device 11 refers to the stored wide-area map information and outputs map information for a relatively narrow area including the current location represented by the positioning information (for example, an area of 100 m² to 10 km²), through the in-vehicle network 17 to the location estimating device 12, object detector 13, traveling lane planning device 14 and drive planning device 15.

The location estimating device 12 estimates the location of the vehicle 10 at the camera image acquisition time, based on the road features surrounding the vehicle 10 represented in the camera image acquired by the camera 2a. For example, the location estimating device 12 compares lane marking lines identified in the camera image with lane marking lines represented in the map information input from the map information storage device 11, and determines the estimated location and estimated declination of the vehicle 10 at the camera image acquisition time. The location estimating device 12 estimates the road traveling lane where the vehicle 10 is located, based on the lane marking lines represented in the map information and on the estimated location and estimated declination of the vehicle 10. Each time the estimated location, estimated declination and traveling lane of the vehicle 10 are determined at the camera image acquisition time, the location estimating device 12 outputs this information to the object detector 13, traveling lane planning device 14 and drive planning device 15.

The object detector 13 detects objects around the vehicle 10 and their types (for example, vehicles) based on the camera image, for example. Other objects also include other vehicles traveling around the vehicle 10. The object detector 13 tracks detected objects and determines the trajectories and speeds of the other objects. The object detector 13 identifies the traveling lanes in which the objects are traveling, based on the lane marking lines represented in the map information and the locations of the objects. The object detector 13 also outputs object detection information which includes information representing the types of objects that were detected, information indicating their locations and speeds, and also information indicating their traveling lanes, to the traveling lane planning device 14 and drive planning device 15.

The traveling lane planning device 14 carries out plan processing, determination processing, decision processing and control processing. The traveling lane planning device 14 has a communication interface (IF) 21, a memory 22 and a processor 23 for this purpose. The communication interface 21, memory 22 and processor 23 are connected via signal wires 24. The communication interface 21 has an interface circuit to connect the traveling lane planning device 14 with the in-vehicle network 17.

The memory 22 is an example of a storage unit, and it has a volatile semiconductor memory and a non-volatile semiconductor memory, for example. The memory 22 stores an application computer program and various data to be used for information processing carried out by the processor 23.

All or some of the functions of the traveling lane planning device 14 are functional modules driven by a computer program operating on the processor 23, for example. The processor 23 has a planning unit 231, a determining unit 232, a deciding unit 233 and a control unit 234. Alternatively, the functional module of the processor 23 may be a specialized computing circuit in the processor 23. The processor 23 comprises one or more CPUs (Central Processing Units) and their peripheral circuits. The processor 23 may also have other computing circuits such as a logical operation unit, numerical calculation unit or graphics processing unit. The traveling lane planning device 14 is an electronic control unit (ECU), for example.

At a traveling lane-planning creation time set in a predetermined cycle, the planning unit 231 selects a traffic lane on the road on which the vehicle 10 is traveling, within the nearest driving zone (for example, 10 km) selected from the navigation route, based on the map information, the navigation route and surrounding environment information and the current location of the vehicle 10, and creates a traveling lane plan representing the scheduled traveling lane for traveling of the vehicle 10. The surrounding environment information includes the locations and speeds of other vehicles traveling around the vehicle 10. For example, the traveling lane planning device 14 creates a traveling lane plan for the vehicle 10 to travel on a traffic lane other than a passing traffic lane. Each time a traveling lane plan is created, the traveling lane planning device 14 outputs the traveling lane plan to the drive planning device 15.

The planning unit 231 also determines whether or not a lane change is necessary within the nearest driving zone selected from the navigation route, based on the traveling lane plan, the map information, the navigation route and the current location of the vehicle 10, and generates a lane change plan in accordance with the determination results. Specifically, the planning unit 231 determines whether or not a lane change is necessary for moving to a traffic lane toward the destination location of the vehicle 10, based on the navigation route and the current location of the vehicle 10. The planning unit 231 determines whether or not the vehicle 10 is approaching another road that merges ahead from the traveling road on which it is currently traveling (merge), or the vehicle 10 is exiting onto another road branching out ahead from the traveling road (branch). Since merging and branching involve movement of the vehicle from a lane of the traveling road to a lane in another road, a lane change is carried out. The planning unit 231 may further utilize surrounding environment information or vehicle status information to determine whether or not a lane change is necessary. The vehicle status information includes the current location of the vehicle 10, and the vehicle speed, acceleration and traveling direction. The traveling lane planning device 14 may also generate lane change plans in response to requests for movement between lanes by the driver.

When it has determined that a lane change is necessary, the planning unit 231 decides on the target lane and destination lane before moving. The planning unit 231 sets on the target lane a lane change completion location where movement of the vehicle from the target lane to the other lane is to be completed. The planning unit 231 also generates a lane change plan that includes moving the vehicle 10 from the lane in which it is traveling to the target lane, and moving the vehicle 10 from the target lane to another lane before it reaches the lane change completion location. When a lane change plan has been generated, the planning unit 231 outputs the traveling lane plan with the added lane change plan to the drive planning device 15. The planning unit 231 also notifies the determining unit 232 of the lane change plan.

In the example shown in FIG. 1A, the planning unit 231 sets a first lane change completion location on the lane 51, sets a second lane change completion location on the lane 52 and sets a third lane change completion location P1 on the lane 53. The planning unit 231 schedules movement from the lane 51 to the lane 52 before reaching the first lane change completion location in the lane 51. The planning unit 231 also schedules movement from the lane 52 to the lane 53 before reaching the second lane change completion location in the lane 52. The planning unit 231 further schedules movement from the lane 53 to the lane 61 before reaching the third lane change completion location P1 in the lane 53.

The planning unit 231 sends an information request for zone information to an external server (not shown), at an information acquisition time with a predetermined cycle. The zone information includes the location of the difficult traveling zone D where traveling of the vehicle 10 is difficult. Upon receiving the zone information from the external server (not shown), the planning unit 231 acquires the location of the difficult traveling zone. The location of the difficult traveling zone is used for the subsequent vehicle control processing.

The planning unit 231 may also receive traffic information including the current locations and speeds of other vehicles, from other vehicles located in a predetermined range from the vehicle 10, via the communication device 3. Based on traffic information, the planning unit 231 determines the average speed and average intervehicular distance for the road in which the vehicle 10 is traveling, and for each lane of the road. The planning unit 231 may also decide that a zone in which the average speed is below a reference speed, or the average intervehicular distance is a reference intervehicular distance, is a difficult traveling zone. In this case the traveling lane planning device 14 does not need to receive zone information from the external server. Other operations carried out by the traveling lane planning device 14 are described below.

At a driving plan creation time set with a predetermined cycle, the drive planning device 15 creates a driving plan representing the scheduled traveling trajectory of the vehicle 10 up until a predetermined time (for example, 5 seconds), based on the traveling lane plan, the map information, the current location of the vehicle 10, the surrounding environment information and the vehicle status information. The driving plan is represented as a combination of the target location of the vehicle 10 and the target vehicle speed at the target location, at each time from the current time until the predetermined time. The drive planning device 15 generates a driving plan to maintain a spacing of at least a predetermined distance between the vehicle 10 and other vehicles. The drive planning device 15 outputs the driving plan to the vehicle control device 16 for each driving plan generated.

The vehicle control device 16 controls each unit of the vehicle 10 based on the current location of the vehicle 10 and the vehicle speed and yaw rate, as well as on the driving plan generated by the drive planning device 15. For example, the vehicle control device 16 determines the steering angle, acceleration and angular acceleration of the vehicle 10 according to the driving plan and the speed and yaw rate of the vehicle 10, and sets the amount of steering, and the accelerator or brake level so as to match that steering angle, accelerator level and angular acceleration. The vehicle control device 16 also outputs a control signal corresponding to a set steering amount, to an actuator (not shown) that controls the steering wheel for the vehicle 10, via the in-vehicle network 17. The vehicle control device 16 also outputs a control signal corresponding to the set accelerator level, to a drive unit such as an engine or motor (not shown) of the vehicle 10, via the in-vehicle network 17. Alternatively, the vehicle control device 16 may output a control signal corresponding to a set brake level to the brake (not shown) of the vehicle 10, via the in-vehicle network 17.

For FIG. 2, the map information storage device 11, location estimating device 12, object detector 13, traveling lane planning device 14, drive planning device 15 and vehicle control device 16 were explained as separate devices, but all or some of them may be constructed in a single device.

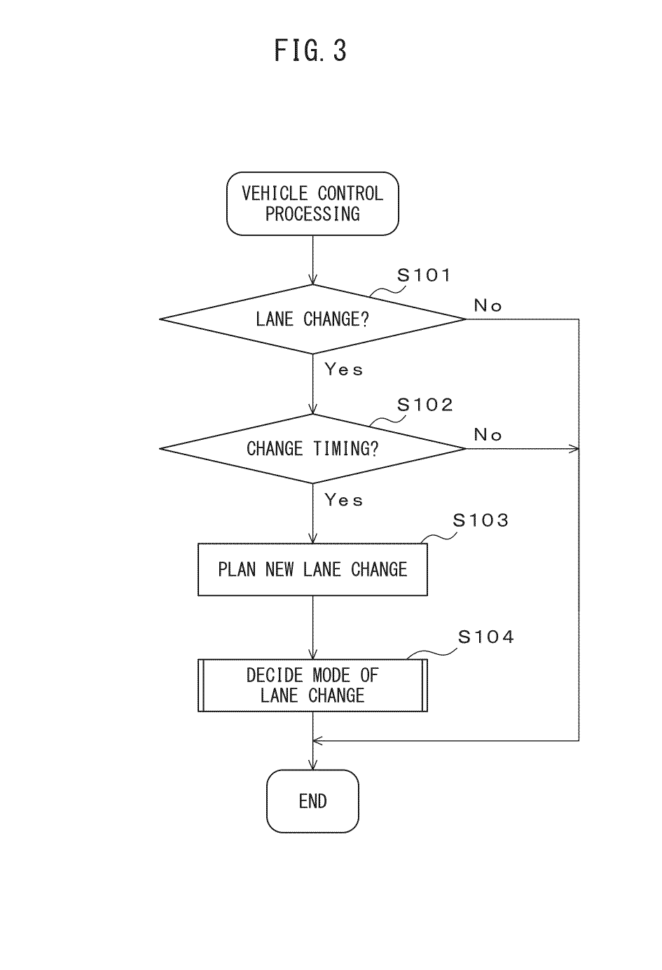

FIG. 3 is an example of an operation flow chart for vehicle control processing by a traveling lane planning device 14. Vehicle control processing by the traveling lane planning device 14 will now be described with reference to FIG. 3. The traveling lane planning device 14 carries out vehicle control processing according to the operation flow chart shown in FIG. 3, at a vehicle control time having a predetermined cycle.

First, the determining unit 232 determines whether or not a lane change for the vehicle 10 is scheduled based on the traveling lane plan generated by the planning unit 231 (step S101). When a lane change plan is included in the traveling lane plan, the determining unit 232 determines that a lane change is scheduled for the vehicle 10.

When a lane change is scheduled for the vehicle 10 (step S101 - Yes), the determining unit 232 determines whether or not the timing to initiate the scheduled lane change is to be altered, based on the environment information for the vehicle surroundings (step S102). For example, the determining unit 232 determines whether or not a difficult traveling zone is located between the current location of the vehicle 10 and the lane change completion location. The determining unit 232 determines whether or not a difficult traveling zone is located between the current location of the vehicle 10 and the lane change completion location based on zone information or map information.

When a difficult traveling zone is located between the current location of the vehicle 10 and the lane change completion location (step S102 - Yes), the determining unit 232 determines that the timing to initiate the scheduled lane change (first lane change) is to be altered.

The planning unit 231 then plans a new lane change (second lane change) based on the location of the difficult traveling zone (step S103). When the difficult traveling zone is a congested zone, the planning unit 231 plans to execute a lane change for movement of the vehicle 10 to the target lane before the vehicle 10 reaches the congested zone, or to execute a lane change for movement of the vehicle to a target lane after the vehicle 10 has passed through the congested zone. This is because the vehicle 10 may not be able to safely carry out movement between lanes by automatic control in the difficult traveling zone.

When the difficult traveling zone is one where the lane in which the vehicle 10 is traveling is closed due to construction, for example, the planning unit 231 may plan to execute a lane change for movement of the vehicle 10 to the target lane before the vehicle 10 reaches the congested zone.

When the difficult traveling zone is one where the road surface is frozen, it may be planned to execute a lane change for movement of the vehicle 10 to the target lane before the vehicle 10 reaches the congested zone, or to execute a lane change for movement of the vehicle to a target lane after the vehicle 10 has passed through the congested zone.

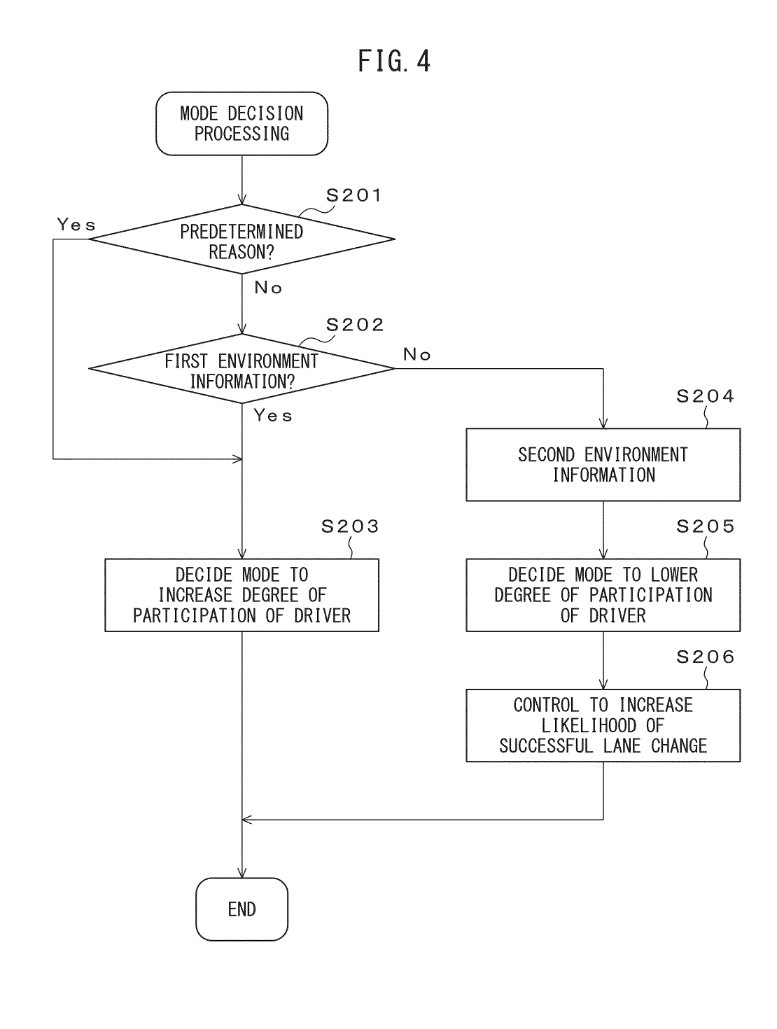

The deciding unit 233 then decides on a mode of control for the second lane change, based on the reason for executing the first lane change, or on the environment information for the vehicle surroundings for which the timing to initiate the first lane change has been altered (step S104), and the series of processing steps is complete. Decision processing for the mode of control for the second lane change will be described with reference to FIG. 4.

The deciding unit 233 notifies the planning unit 231 of the mode of control for the second lane change. The planning unit 231 generates a traveling lane plan with a lane change including the mode of control for the second lane change.

When lane change has not been scheduled for the vehicle 10 (step S101 - No), or when a difficult traveling zone does not exist (step S102 - No), the series of processing steps is complete.

Mode decision processing by the traveling lane planning device 14 will now be described with reference to FIG. 4. FIG. 4 is an example of an operation flow chart for mode decision processing by a traveling lane planning device.

First, the deciding unit 233 determines whether or not the reason for executing the first lane change qualifies as a predetermined reason (step S201). The predetermined reason may be that the first lane change is for the purpose of allowing the vehicle 10 to reach the destination location.

For example, the lane change may be scheduled in order to exit to a branching road to reach the destination location, or due to a merge with another road. Such a lane change may also be scheduled because the lane in which the vehicle 10 is traveling vanishes. Such a lane change could also be because the lane in which the vehicle 10 is traveling is closed off due to construction, for example. If the vehicle 10 can no longer travel in the lane in which it is traveling, the vehicle 10 will not be able to reach the destination location.

Some lane changes, on the other hand, may be scheduled for a reason other than for the vehicle 10 to reach the destination location. Such lane changes include lane changes to avoid a merge zone where another vehicle is merging from another lane, lane changes to avoid approach of the vehicle 10 into an upwardly inclined lane, and lane changes to avoid approach into an HOV lane. Such lane changes also include lane changes to move the vehicle 10 into the original lane after having passed a vehicle ahead. Such lane changes still further include lane changes to move the vehicle 10 into a higher speed lane.

When the reason for executing a first lane change does not qualify as a predetermined reason (step S201 - No), the deciding unit 233 determines whether or not the environment information for the vehicle surroundings used to alter the timing to initiate the first lane change qualifies as first environment information (step S202). The environment information for the vehicle surroundings is information that was not recognized when scheduling the first lane change.

The first environment information includes indication that the vehicle 10 will no longer be able to reach the destination location. The first environment information may be that the lane in which the vehicle 10 is traveling vanishes, or that it is closed due to construction, for example.

When the reason for executing the first lane change qualifies as a predetermined reason (step S201 - Yes) or the environment information for the vehicle surroundings qualifies as first environment information (step S202 - Yes), the deciding unit 233 decides on the mode of control for the second lane change so that the degree of participation of the driver is higher (step S203), and the series of processing steps is complete.

The deciding unit 233 decides on proposal-approval mode or manual control mode for the mode of control for the second lane change when the mode of control for the first lane change is non-approval mode. When the mode of control for the first lane change is proposal-approval mode, the deciding unit 233 decides on manual control mode for the mode of control for the second lane change. When the mode of control for the first lane change is automatic control mode in which lane change operation is carried out by self-driving of the vehicle 10, the deciding unit 233 decides on manual control mode in which lane change operation is carried out by manual driving by the driver, as the mode of control for the second lane change. When the mode of control for the first lane change is manual control mode in which the lane change is carried out by manual driving by the driver, no change is made to the mode of control for the second lane change.

When the mode of control for the second lane change is manual control mode, the control unit 234 notifies the driver via the UI 6 that a lane change is to be made in manual control mode. In particular, when it has been decided that the mode of control for the second lane change is a mode in which the lane change is carried out by manual driving by the driver, the control unit 234 notifies the driver via the UI 6 that the driver should take care when making the lane change. The control unit 234 can thus increase the degree of participation of the driver by alerting the driver to be more careful when driving.

When the mode of control for the first lane change was manual control mode in which the lane change is carried out by manual driving by the driver, the control unit 234 may notify the driver via the UI 6 that the lane change is for the purpose of the vehicle 10 reaching the destination location.

Throughout the present specification, “non-approval mode” is a mode in which the vehicle 10 does not receive approval from the driver each time a lane change is initiated. For example, non-approval mode includes receiving comprehensive approval from the driver for lane changes during initial setup of the vehicle. Proposal-approval mode, on the other hand, is a mode in which approval from the driver is received each time a lane change is initiated.

By thus deciding on a mode of control for the second lane change so that the degree of participation of the driver is increased, it is possible to increase the likelihood of successfully making a lane change for the vehicle 10 to reach the destination location.

When the environment information for the vehicle surroundings does not qualify as first environment information (step S202 - No), on the other hand, the deciding unit 233 determines that the environment information for the vehicle surroundings qualifies as second environment information (step S204). The second environment information includes information other than information that the vehicle 10 will no longer be able to reach the destination location.

For example, the second environment information includes information that the difficult traveling zone is a congested zone, that the road surface is frozen in the difficult traveling zone, that the difficult traveling zone is a merge zone, or that a lane other than the lane in which the vehicle 10 is currently traveling is under construction, within the difficult traveling zone. In such cases it is possible that the time at which the vehicle 10 reaches the destination location will be delayed but that the vehicle 10 can still reach the destination location by traveling in the current traveling lane.

The deciding unit 233 then decides on a mode of control for the second lane change so that the degree of participation of the driver is lowered (step S205), and the series of processing steps is complete. In some embodiments, when the environment surrounding the vehicle is not such that the vehicle 10 cannot reach the destination location, the lane change may be by automatic control from the viewpoint of avoiding increased burden on the driver.

The deciding unit 233 decides on non-approval mode or proposal-approval mode for the mode of control for the second lane change when the mode of control for the first lane change is manual control mode. When the mode of control for the first lane change is proposal-approval mode, the deciding unit 233 decides on non-approval mode for the mode of control for the second lane change . When the mode of control for the first lane change was already non-approval mode, the deciding unit 233 makes no change to the mode of control for the second lane change.

The deciding unit 233 then decides on control so as to increase the likelihood of a successful lane change by automatic control (step S206), and the series of processing steps is complete.

The following manner of control may be used to increase the likelihood of a successful lane change by automatic control. (1) Increasing the allowed standby time from the time point when the lane change schedule is generated until the lane change is executed, (2) increasing the allowed standby time from the time point when scheduling of the lane change is proposed to the driver until approval of the driver is obtained, (3) proposing the lane change scheduling of (2) to the driver with greater emphasis, and (4) relaxing constraints on control of the vehicle 10 during lane changes.

The following methods can relax constraints on control of the vehicle 10 during lane changes for (4). (a) Increasing the restriction limit on lateral traveling speed, (b) increasing the restriction limit on lateral acceleration, (c) increasing the restriction limit on yaw rate, and (d) releasing restrictions on unpermitted lane changes.

The following are examples of releasing restrictions on unpermitted lane changes. Releasing restrictions on zones where movement of the vehicle between lanes cannot be safely controlled by automatic control (on a sharp curve, for example), releasing restrictions on merge zones where other vehicles are merging in, releasing restrictions on zones where lane changes are prohibited by the driver, and releasing restrictions on zones where movement between lanes is physically prohibited. Step S206 can optionally be omitted.

Several methods may also be combined as the control method to increase the likelihood of a successful lane change by automatic control. In addition, several methods of relaxation may be combined to relax restrictions on control of the vehicle 10 during lane changes.

The traveling lane planning device 14 previously proposes to the driver, via the UI 6, to switch to manual control mode when a lane change is not successful after having initiated the second lane change in non-approval mode or proposal-approval mode.

As described in detail above, the traveling lane planning device 14 of the embodiment decides the mode of lane change after its timing to initiate has been altered based on the reason for executing the originally planned lane change or the reason for altering the timing to initiate the lane change, making it possible to increase the likelihood of a successful lane change after the timing to initiate has been altered.

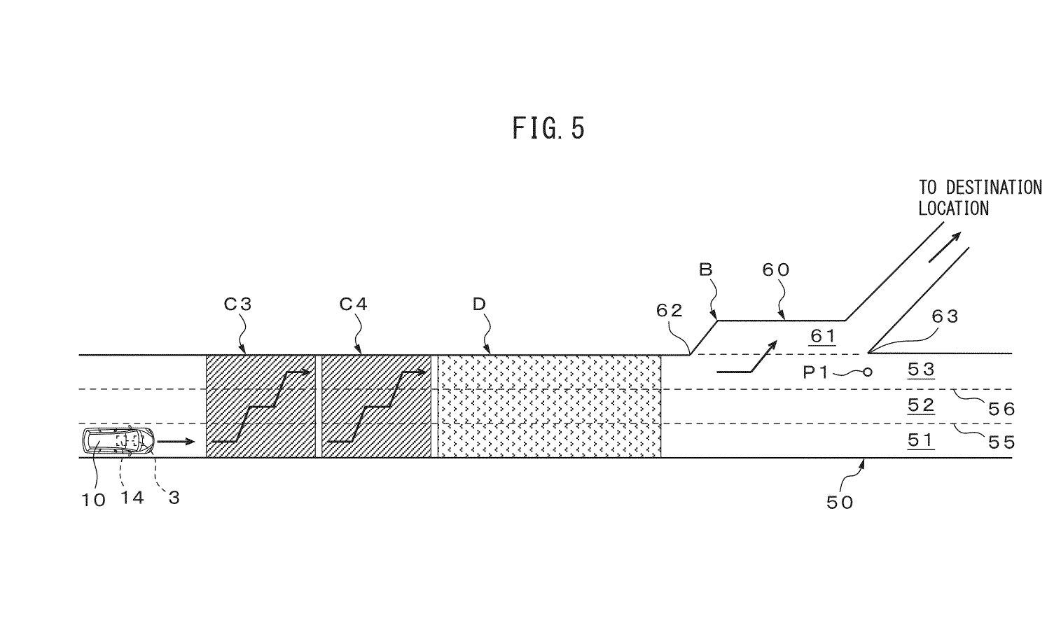

Further operation for mode decision processing by the traveling lane planning device 14 of the embodiment will now be explained with reference to FIG. 5. FIG. 5 is a diagram illustrating a different example of mode decision processing by the traveling lane planning device 14 of the embodiment.

The deciding unit 233 then decides on a mode of control for the second lane change, based on the reason for executing the first lane change, or on the environment information for the vehicle surroundings due to which the timing to initiate the first lane change has been altered, together with the difference between the timing to initiate the second lane change and the timing to initiate the first lane change, as planned by the planning unit 231.

In the example shown in FIG. 5, a difficult traveling zone D exists between the current location of the vehicle 10 and the lane change completion location P1, similar to FIG. 1B.

The planning unit 231 generates a new lane change plan C3 and lane change plan C4 between the current location of the vehicle 10 and the difficult traveling zone D.

The timing to initiate the lane change in the lane change plan C3 is earlier than the timing to initiate the lane change in the lane change plan C4.

The difference between the timing to initiate the lane change in the lane change plan C3 and the timing to initiate the lane change in the lane change plan C1 is greater than the difference between the timing to initiate the lane change in the lane change plan C4 and the timing to initiate the lane change in the lane change plan C1.

The deciding unit 233 decides the mode of control of the lane change plan C3 and lane change plan C4, according to the mode decision processing shown in the FIG. 4. Suppose that for the lane change plan C3 and the lane change plan C4, a mode of control was decided on so as to increase the degree of participation of the driver. Also suppose that the mode of control for the lane change in the lane change plan C1 was non-approval mode. In this case, the deciding unit 233 may use proposal-approval mode as the mode of control for the lane change in the lane change plan C3, and manual control mode as the mode of control for the lane change in the lane change plan C4.

On the other hand, suppose that for the lane change plan C3 and the lane change plan C4, a mode of control was decided on so as to decrease the degree of participation of the driver. Further suppose that the mode of control for the lane change in the lane change plan C1 was manual control mode. In this case, the deciding unit 233 may use non-approval mode as the mode of control for the lane change in the lane change plan C3, and proposal-approval mode as the mode of control for the lane change in the lane change plan C4.

The location where the lane change is carried out according to the lane change plan C3 has a relatively longer distance to the lane change completion location P1, and therefore the lane change is controlled with a lower degree of participation by the driver. The location where the lane change is carried out according to the lane change plan C4, on the other hand, has a relatively shorter distance to the lane change completion location P1, and therefore the lane change is controlled with a higher degree of participation by the driver.

This can increase the likelihood of a successful lane change after altering the timing to initiate the lane change, but without increasing burden on the driver.

The vehicle control device according to the embodiment described above may incorporate appropriate modifications that are still within the gist of the present disclosure. Moreover, the technical scope of the present disclosure is not limited to the embodiments described herein and includes the present disclosure and its equivalents as laid out in the Claims.

For example, according to the embodiment described above the modes of control for lane changing were non-approval mode, proposal-approval mode and manual control mode, but the modes of control for lane changing are not limited to these. For example, the modes of control for lane changing may be modes with different degrees of participation of the driver. The different degrees of participation by the driver may also be expressed in terms of the degree of participation by automatic control.

Moreover, in the embodiment described above the lane change plan included several movements between lanes from the lane in which the vehicle is currently traveling, but the present disclosure may also be applied in cases where the lane change plan carries out a single movement between lanes.

According to the embodiment described above, the timing to initiate a lane change was altered when a difficult traveling zone existed between the current location of the vehicle and lane change completion location, but the reason for altering the timing to initiate the lane change is not limited to this reason. For example, the present disclosure can be applied even in cases where the scheduled timing to initiate a lane change has been altered because at least a reference distance cannot be maintained between the vehicle and other objects.

Moreover, according to the embodiment described above, the traveling lane planning device decided on a mode of control for the second lane change, based on the reason for executing the first lane change, or on the environment information for the vehicle surroundings due to which the timing to initiate the first lane change was altered. However, the traveling lane planning device may also decide on a mode of control for the second lane change based on the reason for executing the first lane change. The traveling lane planning device may also decide on a mode of control for the second lane change, based on the environment information for the vehicle surroundings due to which the timing to initiate the first lane change was altered.

The method of acquiring the location of the difficult traveling zone by the traveling lane planning device is also not limited to the method described above. The traveling lane planning device may acquire the location of the difficult traveling zone using any other method.

1. A vehicle control device comprising:
a processor configured to
determine whether or not timing to initiate a scheduled first lane change is to be altered based on environment information for vehicle surroundings,
plan a second lane change based on the environment information for the vehicle surroundings, when it has been determined that the timing to initiate the first lane change is to be altered, and
decide on a mode of control for the second lane change based on a reason for executing the first lane change, or on the environment information for the vehicle surroundings for which the timing to initiate the first lane change has been altered, when the second lane change has been planned.

2. The vehicle control device according to claim 1, wherein the processor is further configured to decide on the mode of control for the second lane change so as to increase a degree of participation of a driver when the reason for executing the first lane change is a lane change for a vehicle to reach a destination location, or when the environment information for the vehicle surroundings indicates that the vehicle is no longer able to reach the destination location.

3. The vehicle control device according to claim 1, wherein the processor is further configured to decide on the mode of control for the second lane change so as to lower a degree of participation of a driver, when the environment information for the vehicle surroundings does not indicate that a vehicle is no longer able to reach a destination location.

4. The vehicle control device according to claim 3, wherein the processor is further configured to decide on the mode of control for the second lane change while also deciding on the mode of control so as to increase a likelihood of a successful lane change by automatic control.

5. The vehicle control device according to claim 1, wherein the processor is further configured to decide on the mode of control for the second lane change, based on (A) the reason for executing the first lane change, or (B) the environment information for the vehicle surroundings for which the timing to initiate the first lane change has been altered, together with (C) a difference between the timing to initiate the second lane change and the timing to initiate the first lane change.
